(19) United States
(12) Patent Application Publication
(10) Pub. No.: US 2026/0320946 A1
(43) Pub. Date: Oct. 15, 2026

(54) OBJECT DISPLAY METHOD, APPARATUS, DEVICE, AND STORAGE MEDIUM

(71) Applicant: Beijing Dongchezu Technology Co., Ltd., Beijing (CN)

(72) Inventor: Tianyi YANG, Beijing (CN)

(21) Appl. No.: 19/467,947

(22) Filed: Feb. 3, 2026

Related U.S. Application Data
(63) Continuation of application No. PCT/CN2024/109336, filed on Aug. 1, 2024.

(30) Foreign Application Priority Data
Aug. 3, 2023 (CN) 2023109748197

(51) Int. Cl. G06T 19/20; G06T 15/20; G06F 3/04845

(52) U.S. Cl. CPC G06T 19/20; G06T 15/205; G06F 3/04845; G06T 2200/24; G06T 2219/2016

(57) ABSTRACT

Embodiments of the present disclosure disclose an object display method, apparatus, device, and storage medium. The method includes: triggering entry into a view display mode of a target object, and displaying one image frame of the target object; the image frame is one image frame in an image set, the image set includes a plurality of image frames corresponding to the target object, and each image frame corresponds to a different display angle interval; in response to a view rotation instruction in a current view rotation mode, determining a to-be-displayed image frame from the image set based on a current display angle interval corresponding to the currently displayed image frame and rotation information in the view rotation mode, and displaying the to-be-displayed image frame.

This application claims the priority of the Chinese invention patent application filed on Aug. 3, 2023, entitled "An Object Display Method, Apparatus, Device, and Storage Medium" with application number 202310974819.7, the entire content of which is incorporated herein by reference.

### FIELD

Embodiments of the present disclosure relate to the field of computer technology, and in particular, to an object display method, apparatus, device, and storage medium.

### BACKGROUND

Currently, when displaying a target object (such as a vehicle) on an electronic platform, a 360-degree panoramic view of the target object is mainly achieved by constructing a three-dimensional model of the target object. This implementation method requires pre-constructing three-dimensional models for target objects of different brands and models. Moreover, for some second-hand defective target objects, even if they are of the same brand and type, the positions of defects or the details of the objects to be displayed may differ. Therefore, it is necessary to pre-construct a three-dimensional model for each target object, which greatly increases the implementation cost and difficulty of object view display.

At the same time, when performing a panoramic view of a target vehicle by rotating the angle of the three-dimensional model based on the three-dimensional modeling of the target vehicle, problems such as frame freezing and unsmooth view display may occur due to high consumption of computing resources, which not only affects computing performance but also impacts the display effect.

### SUMMARY

Embodiments of the present disclosure provide an object display method, apparatus, computer device, and storage medium to achieve effective view display of target objects.

In a first aspect, an embodiment of the present disclosure provides an object display method, the method including:

Triggering entry into a view display mode of a target object, and displaying one image frame of the target object; the image frame is one image frame in an image set, the image set includes a plurality of image frames corresponding to the target object, and each image frame corresponds to a different display angle interval;

In response to a view rotation instruction in a current view rotation mode, determining a to-be-displayed image frame from the image set based on a current display angle interval corresponding to the currently displayed image frame and rotation information in the view rotation mode, and displaying the to-be-displayed image frame.

In a second aspect, an embodiment of the present disclosure further provides an object display apparatus, the apparatus comprising:

A first display module, configured to trigger entry into a view display mode of a target object, and display one image frame of the target object; the image frame is one image frame in an image set, the image set includes a plurality of image frames corresponding to the target object, and each image frame corresponds to a different display angle interval;

A second display module, configured to respond to a view rotation instruction in a current view rotation mode, determine a to-be-displayed image frame from the image set based on a current display angle interval corresponding to the currently displayed image frame and rotation information in the view rotation mode, and display the to-be-displayed image frame.

In a third aspect, an embodiment of the present disclosure further provides a computer device, the computer device comprising:

One or more processors;

A storage device, configured to store one or more programs, wherein when the one or more programs are executed by the one or more processors, the one or more processors

implement the object display method provided by any embodiment of the present disclosure.

In a fourth aspect, an embodiment of the present disclosure further provides a computer-readable storage medium, on which a computer program is stored, and when the computer program is executed by a processor, the object display method provided by any embodiment of the present disclosure is implemented.

### BRIEF DESCRIPTION OF DRAWINGS

To more clearly illustrate the technical solutions of the exemplary embodiments of the present disclosure, a brief description of the drawings required for describing the embodiments is provided below. Obviously, the described drawings are only a part of the embodiments of the present disclosure, not all of them. For those of ordinary skill in the art, other drawings can be obtained based on these drawings without creative efforts.

FIG. 1 is a schematic flowchart of an object display method provided by an embodiment of the present disclosure;

FIG. 2 is a schematic flowchart of an object display method provided by an embodiment of the present disclosure;

FIG. 3 is a schematic structural diagram of an object display apparatus provided by an embodiment of the present disclosure;

FIG. 4 is a schematic structural diagram of a computer device provided by an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as being limited to the embodiments set forth herein. On the contrary, these embodiments are provided for a

more thorough and complete understanding of the present disclosure. It should be understood that the drawings and embodiments of the present disclosure are only for illustrative purposes and are not intended to limit the scope of the present disclosure.

It should be understood that the steps recorded in the method implementations of the present disclosure can be executed in different orders and/or in parallel. In addition, method implementations may include additional steps and/or omit executing the shown steps. The scope of the present disclosure is not limited in this regard.

The term "including" and its variations used herein are open-ended inclusions, i.e., "including but not limited to". The term "based on" is "at least partially based on". The term "one embodiment" means "at least one embodiment"; the term "another embodiment" means "at least one additional embodiment"; the term "some embodiments" means "at least some embodiments". Relevant definitions of other terms will be given in the following description.

It should be noted that the concepts of "first" and "second" mentioned in the present disclosure are only used to distinguish different devices, modules, or units, and are not used to limit the order or interdependence of the functions performed by these devices, modules, or units. It should be noted that the modification of "one" or "multiple" mentioned in the present disclosure is illustrative rather than restrictive. Those skilled in the art should understand that unless clearly indicated in the context, it should be understood as "one or more".

The names of messages or information interacted between multiple devices in the implementations of the present disclosure are only for illustrative purposes and are not intended to limit the scope of these messages or information.

It should be understood that before using the technical solutions disclosed in the embodiments of the present disclosure, the user should be informed of the type, scope of use, usage scenarios, etc., of the personal information involved in the present disclosure in an appropriate manner in accordance with relevant laws and regulations, and the user's authorization should be obtained.

For example, in response to receiving an active request from the user, a prompt message is sent to the user to clearly inform the user that the operation they request to perform will require the acquisition and use of the user's personal information. Thus, the user can independently choose whether to provide personal information to the software or hardware such as electronic devices, applications, servers, or storage media that execute the technical solutions of the present disclosure based on the prompt message.

As an optional but non-limiting implementation, in response to receiving an active request from the user, the way to send a prompt message to the user may be, for example, a pop-up window, in which the prompt message can be presented in text form. In addition, the pop-up window can also carry selection controls for the user to choose "agree" or "disagree" to provide personal information to the electronic device.

It should be understood that the above notification and user authorization acquisition process is only illustrative and does not constitute a limitation on the implementation of the present disclosure. Other methods that comply with relevant laws and regulations can also be applied to the implementation of the present disclosure.

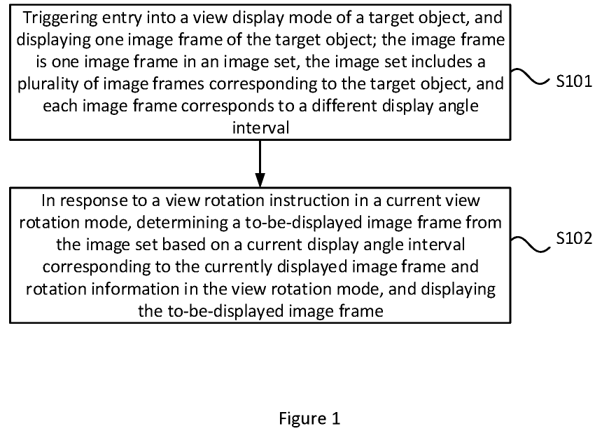

FIG. 1 is a schematic flowchart of an object display method provided by Embodiment 1 of the present disclosure. This embodiment is applicable to the situation of displaying a 360-degree panoramic view or a partial interval angle view of a target object. The method can be executed by an object display apparatus, which can be implemented by software and/or hardware and can be configured in a terminal and/or server to implement the object display method in the embodiments of the present disclosure.

It should be noted that most of the existing methods for realizing object view display rely on the view display of the three-dimensional model of the object. However, with the diversification of object brands and types, the cost of constructing three-dimensional models of objects has increased significantly. Especially for objects (products) involved in second-hand transactions, different second-hand products have different defects, and it is necessary to construct three-dimensional models for each second-hand product, which greatly increases the display difficulty of object display. At the same time, the existing object view display is mainly realized by rotating the angle of the three-dimensional model of the object, which requires more computing performance to support. Therefore, there may also be problems of frame freezing and unsmooth display, affecting the display effect.

The technical solution of the embodiment of the present disclosure specifically discloses an object display method, apparatus, computer device, and storage medium. The method includes: triggering entry into a view display mode of a target object, and displaying one image frame of the target object; the image frame is one image frame in an image set, the image set includes a plurality of image frames corresponding to the target object, and each image frame corresponds to a different display angle interval; in response to a view rotation instruction in a current view rotation mode, determining a to-be-displayed image frame from the image set based on a current display angle interval corresponding to the currently displayed image frame and rotation information in the view rotation mode, and displaying the to-be-displayed image frame. The above technical solution pre-shoots image frames of different display angle intervals in a 360-degree all-round manner for each target object to be displayed in a view. Thus, the three-dimensional display effect using the existing three-dimensional model can be visually simulated by displaying image frames under different display angle intervals. The technical solution eliminates the need to construct a three-dimensional model for each object, greatly reducing the view display cost and display difficulty of the object, reducing the performance waste of computing resources, and effectively solving the problems of frame freezing and unsmooth view display. At the same time, in the object display realized by the technical solution provided in this embodiment, the currently required to-be-displayed image frame of the object can be determined according to the different current view rotation modes, that is, the corresponding to-be-displayed image frame varies with the different active view rotation modes, thereby enriching the display forms of object display and reflecting the diversified display of the panoramic view of the object.

The object display method provided in this embodiment can better solve the problems caused by the existing object display.

As shown in FIG. 1, the object display method provided in this embodiment may specifically include the following steps.

S101: Triggering entry into a view display mode of a target object, and displaying one image frame of the target object; the image frame is one image frame in an image set, the image set includes a plurality of image frames corresponding to the target object, and each image frame corresponds to a different display angle interval.

In this embodiment, one of the application scenarios of view display may be an electronic trading platform for product object transactions. The target object may be any product object selected by consumers or browsers that they want to know specific details about. Taking the target vehicle trading application scenario as an example, the target object may be a target vehicle for which specific details are desired, and this embodiment can realize the view display of the target object on the electronic trading platform involved in the target vehicle. The following description of this embodiment mainly takes the target object as a target vehicle for illustrative purposes, but the target object is not limited to a target vehicle.

In this embodiment, after selecting a target vehicle on an electronic trading platform for which they want to know specific details, consumers or browsers can enter the detailed display interface of the target vehicle, and can trigger a function item associated with the view display mode when there is a demand for view display of the target vehicle. This step can enter the view display mode of the target vehicle through the received trigger instruction.

The key to displaying the view of the target vehicle in this embodiment lies in capturing images of the target vehicle in a 360-degree panoramic view. Therefore, before implementing the method provided in this embodiment, it is necessary to take 360-degree all-round images of the target vehicle. For example, in one shooting implementation, 360 degrees can be divided into a plurality of display angle intervals (for example, 360 degrees can be divided into 36 different display angle intervals according to 10 degrees), and then the target vehicle is photographed in different display angle intervals in a given shooting cabin. The shooting form may include photographing the exterior of the target vehicle, photographing the target vehicle with doors open, photographing the interior details of the target vehicle, and defects, etc., that is, one image frame can be captured in different shooting forms under different display angle intervals. In this embodiment, a corresponding image set can be formed according to different shooting forms, and the image set includes image frames of the target object in different display angle intervals under the shooting form.

In some embodiments, the view display may be a panoramic view display or a display of a partial display angle view in the panoramic view. In some embodiments, the panoramic view may be considered as a 360-degree panoramic view, which may correspond to a circle in a spatial orientation. The circle may be divided into a plurality of display angle intervals, and each display angle interval has the same interval angle. The different display angle intervals under the panoramic view in this embodiment may be considered as display angle intervals formed by dividing the 360-degree panoramic view. For the effective display of the target object, this embodiment captures image frames of the target object in a 360-degree panoramic view in advance.

After entering the view display mode, this embodiment can load the captured image frames under different display angle intervals through this step and display the image frame of one display angle interval. The displayed image frame may be the image frame corresponding to the display angle interval in one of the above shooting forms. This embodiment preferably loads the image set under the vehicle exterior shooting form, which includes image frames of the vehicle exterior shooting form in different display angle intervals, and displays the image frame of a certain display angle interval.

It should be noted that in the implementation of image frame display, the loading operation performed in this step may take a period of time. During the execution of the loading operation, a loading animation can be displayed in the screen display area of the presented screen interface, and the image frame corresponding to the target vehicle in a set display angle interval can be displayed at a low resolution.

This embodiment can detect and determine the completion of loading during the execution of the loading operation, and can enter the execution logic of displaying image frames after detecting the completion of loading. It should be understood that for the view display of the target vehicle, it is equivalent to realizing the display of image frames corresponding to the target vehicle in different display angle intervals in sequence. At the visualization level, this display effect can be described as presenting the target vehicle rotating in space to realize the view display of image frames of the target vehicle from different perspectives.

S102: In response to a view rotation instruction in a current view rotation mode, determining a to-be-displayed image frame from the image set based on a current display angle interval corresponding to the currently displayed image frame and rotation information in the view rotation mode, and displaying the to-be-displayed image frame.

In this embodiment, the view display of the target vehicle can be abstracted as the view rotation display of the target vehicle, which can be specifically embodied as the sequential display of image frames corresponding to different display angle intervals. To realize the execution logic of this view rotation display, it is necessary to perform rotation control of the view rotation. In this embodiment, different control methods of the rotation control can be determined by the current view rotation mode.

In this embodiment, the view rotation instruction in the current view rotation mode can be understood as an instruction initiated to change the content of the view display from the currently displayed image frame to the next to-be-displayed image frame. In the automatic view rotation mode, the view rotation instruction can be formed according to the rotation characteristics of the automatic view rotation, such as continuously generating view rotation instructions according to a set cycle; in the passive view rotation mode, the view rotation instruction can be formed through passive sliding control of the displayed target object, such as triggering the generation of the next view rotation instruction by receiving a sliding control of the target object in the currently displayed image frame.

This step can respond to the view rotation instruction generated in the current view rotation mode to determine the to-be-displayed image frame corresponding to the view rotation instruction and display the to-be-displayed image frame. Specifically, the current view rotation mode can be an automatic view rotation mode or a passive view rotation mode, and different rotation modes are triggered to enter respectively.

In this embodiment, different rotation forms can be set for different view rotation modes. For example, the automatic view rotation mode can be set to uniform view rotation, and the passive view rotation mode can be set to rotate at a rotation speed passively controlled by a third party. In some embodiments, the passive control by a third party may be a touch sliding control of the target object displayed in the screen display area in the view display mode, or a cursor sliding control of the target object displayed in the screen display area in the view display mode. In some embodiments, different view rotation modes correspond to corresponding rotation information. The rotation information can be understood as information representing the rotation characteristics of the view rotation mode. The above setting contents under different view rotation modes can be used as part of the rotation information.

In this embodiment, the currently displayed image frame can be considered as the image frame presented for the view display of the target object before responding to the view rotation instruction at the response execution time. Through the association relationship between the image frame and the display angle interval, the current display angle interval corresponding to the currently displayed image frame can be obtained. This step can first determine the to-be-displayed angle interval based on the current display interval and the rotation information in the current view rotation mode, and then use the image frame corresponding to the determined to-be-displayed angle interval in the image set as the to-be-displayed image frame for display. In some embodiments, the to-be-displayed angle interval can be understood as the angle interval for displaying the target object that needs to be rotated to in response to the view rotation instruction.

Continuing the above description, for the determination of the to-be-displayed angle interval, it can be considered that the determination logic executed under different current view rotation modes is different. Specifically, different to-be-displayed angle intervals can be determined according to the different rotation information corresponding to different view rotation modes. For example, when the rotation information in the automatic view rotation mode is uniform rotation at a first speed, the corresponding determined interval may be a first to-be-displayed angle interval; while in the passive view rotation mode, the second speed adopted and the sliding speed during passive control by a third party can be used as rotation information, and the second to-be-displayed angle interval corresponding to the passive view rotation mode can be determined based on the above rotation information. Since the second speed is faster when sliding is faster and slower when sliding is slower, it is equivalent that the rotation information under different view rotation modes is different. Therefore, the determined second to-be-displayed angle interval is different from the above first to-be-displayed angle interval.

In this embodiment, one of the implementation methods for determining the to-be-displayed angle interval in the active view rotation mode can be described as: under a uniform rotation speed, combined with the current display angle interval, it is determined how many angle values the target vehicle has rotated in the view display mode, and the to-be-displayed angle interval corresponding to the response execution time of the view rotation can be determined by combining the rotation duration determined when dividing the display angle interval.

In this embodiment, another implementation method for determining the current display angle interval in the active view rotation mode can be described as: in the case of passive rotation realized based on third-party control, the sliding distance of the sliding trajectory formed by the passive control by the third party up to the response execution time can be monitored. The sliding distance can determine how many angle values have been rotated in the view display implementation through a mapping relationship, and then the to-be-displayed angle interval corresponding to the response execution time can be determined by combining the interval angle value determined when dividing the display angle interval.

Continuing the above description, in the case of passive rotation realized based on third-party control, the case of buffer rotation after the stop of the passive control by the third party can also be considered. In this case, a buffer parameter for deceleration buffer can be determined according to the sliding speed when the passive control by the third party stops, and then a buffer rotation angle can be determined based on the sliding speed, the buffer parameter, and the time interval from the stop time of the passive control by the third party to the response execution time. After knowing the interval angle value corresponding to each display angle interval, the to-be-displayed angle interval on which the display of the target vehicle through the to-be-displayed image frame depends can be determined through the buffer rotation angle.

It should be noted that the method provided in this embodiment can be equivalent to a cyclic execution logic, that is, with the execution of the execution logic at each execution time, the determination operation of the to-be-displayed angle interval and the corresponding to-be-displayed image frame and the display operation of the to-be-displayed image frame are performed.

The object display method provided in this embodiment pre-shoots image frames of different display angle intervals in a 360-degree all-round manner for each target object to be displayed in a view. Thus, the three-dimensional display effect using the existing three-dimensional model can be visually simulated by displaying image frames under different display angle intervals. The technical solution eliminates the need to construct a three-dimensional model for each object, greatly reduces the view display cost and display difficulty of the object, reduces the performance waste of computing resources, and effectively solves the problems of frame freezing and unsmooth view display. At the same time, in the object display realized by the technical solution provided in this embodiment, the currently required to-be-displayed image frame of the object can be determined according to the different current view rotation modes, that is, the corresponding to-be-displayed image frame varies with the different active view rotation modes, thereby enriching the display forms of object display and reflecting the diversified display of the panoramic view of the object.

As a first optional embodiment of this embodiment, on the basis of the above embodiment, an implementation method for determining the to-be-displayed image frame in the current view rotation mode is given. Specifically, determining the to-be-displayed image frame from the image set based on the current display angle interval corresponding to the currently displayed image frame and the rotation information corresponding to the view rotation mode may include:

a1) In the case where the view rotation mode is an automatic rotation mode, the to-be-displayed angle interval is determined based on the current display angle interval and the uniform rotation speed corresponding to the automatic rotation mode.

In this embodiment, the timing of entering the view rotation mode can be realized by receiving a trigger operation of the view rotation mode or a detected trigger condition of the view rotation mode. Preferably, it may be receiving a trigger operation of a function item for automatic view rotation; or, no other view rotation mode is detected within a set interval duration. This embodiment can detect which specific view rotation mode is current after entering the view display mode, and when it is determined that the automatic view rotation mode is current, the logic operation of this step can be executed to determine the to-be-displayed angle interval.

In some embodiments, the function item for automatic view rotation may be a function control displayed on the screen interface. For the case where no other view rotation mode is detected within a set interval duration, the other view rotation mode may be a passive view rotation mode. This embodiment can be considered to enter the automatic view rotation mode if no passive view rotation mode is detected within the set interval duration. The other view rotation mode may also be a specific view mode provided in the execution of the method of this embodiment, such as a view in a door-open state when the target object is a target vehicle, or a view of an image in a locally enlarged area. The specific view mode can also be triggered according to corresponding trigger conditions. This embodiment can also enter the automatic view rotation mode if no specific view mode is detected within the set interval duration.

In this embodiment, the automatic view rotation mode can be specifically understood as a target vehicle view display mode that can control view rotation according to a set rotation control logic without the intervention of rotation control information generated by an external third party. In some embodiments, the set rotation control logic can limit the rotation speed of the view, such as limiting the view to rotate at a given uniform speed.

Continuing the above description, the view display of the target vehicle realized in this mode can be described as: after obtaining image frames of different display angle intervals, presenting the image frames corresponding to different display angle intervals on the screen interface according to a certain order and rotation speed to simulate the rotating view of the target vehicle in a three-dimensional space. In some embodiments, the uniform rotation speed can be considered as the switching speed of switching the image frame corresponding to one display angle interval to the image frame corresponding to the next display angle interval. That is, the faster the uniform rotation speed, the faster the presentation and switching speed of the image frames corresponding to different display angle intervals.

In this embodiment, the uniform rotation speed adopted in the automatic view rotation mode can be considered as a rotation characteristic under automatic rotation. On the basis of uniform rotation, it can be considered that the time taken to switch from the image frame corresponding to one display angle interval to the image frame corresponding to the next display angle interval on the screen interface is the same.

This embodiment can determine the to-be-displayed angle interval at the response execution time through the uniform rotation speed in the automatic view rotation mode. In some embodiments, the uniform rotation speed can be characterized by the rotation duration of the image frame presented on the screen interface. It can be seen that the display angle interval at the response execution time is either not adjusted if the interval time is not reached, and the current display angle interval remains unchanged; or adjusted when the rotation duration is reached, thereby determining a new to-be-displayed angle interval.

As one implementation method, this step can compare the rotation interval duration associated with the uniform rotation speed with the rotation duration to determine whether to keep the existing current display angle interval unchanged or adjust it to a new display angle interval at the response execution time based on the comparison result. The unchanged current display angle interval or the new display angle interval to be rotated to is recorded as the to-be-displayed angle interval determined in this step.

b1) In the case where the view rotation mode is a passive rotation mode, the to-be-displayed angle interval is determined based on the current display angle interval and the rotation phase corresponding to the passive rotation mode.

In this embodiment, it can be determined that the passive view rotation mode is current when third-party sliding control is detected in the screen display area where image frames are displayed. The passive view rotation mode can also be entered when a trigger condition for passive rotation is received (such as a passive rotation control on the screen interface is triggered). In some embodiments, the automatic view rotation mode and the passive view rotation mode can be freely switched according to the detection of meeting corresponding trigger conditions.

This embodiment can execute this step and subsequent related logic operations to determine the to-be-displayed angle interval when it is determined that the passive view rotation mode is current. In some embodiments, the third-party sliding control can be generated by touch sliding in the screen display area, or by controlling a physical input device such as a mouse to be in a pressed state and then controlling the corresponding cursor to slide in the screen display area.

It should be noted that when performing the view display of the target vehicle through third-party sliding control, it cannot be guaranteed that the passive control is always in a uniform speed mode. Moreover, if the rotation of the panoramic view is stopped immediately when the third-party sliding control stops, the view display effect will also be affected. Therefore, this embodiment considers that the view rotation is still maintained for a period of time after the third-party sliding control stops, and this view rotation is used as a buffer to present the effect of gradually stopping the view rotation.

In this embodiment, the rotation phase corresponding to the passive rotation mode can be regarded as one type of rotation information possessed by the passive rotation mode. After determining that the passive view rotation mode is current, this step further determines which phase of the passive view rotation mode is current. This embodiment can record the view rotation presented when the third-party sliding control acts on the screen display area as the third-party sliding control execution phase, and the phase in which the view rotation continues after the third-party sliding control stops as the buffer rotation phase. In this embodiment, when the passive view rotation mode is in different rotation phases, the execution logic for determining the to-be-displayed image frame is different.

Specifically, when the rotation phase is the third-party sliding control execution phase, the to-be-displayed angle interval can be determined according to the sliding distance of the sliding trajectory formed by the third-party sliding control. When the rotation phase is the buffer rotation phase after the third-party sliding control stops, the to-be-displayed angle interval can be determined according to the sliding speed when the third-party sliding control stops.

c1) The image frame corresponding to the to-be-displayed angle interval is determined from the image set as the to-be-displayed image frame.

It should be noted that the image set includes image frames corresponding to different display angle intervals. This step can determine the image frame corresponding to the to-be-displayed angle interval by searching the image set, which is then recorded as the to-be-displayed image frame.

The above technical solution of this embodiment provides the determination and implementation of the to-be-displayed angle interval in the automatic view rotation mode and the passive view rotation mode. By determining the to-be-displayed angle interval, it is possible to effectively determine what kind of screen presentation of the target vehicle should be performed at the response execution time of the screen interface, so as to ensure the effective view display of the target vehicle. The technical solution of this embodiment provides the effective determination of the basic data required for the execution logic for view display.

On the basis of this first optional embodiment, determining the to-be-displayed angle interval based on the current display angle interval and the uniform rotation speed corresponding to the automatic rotation mode can be further specified as the following steps:

a11) The interval entry time of the current display angle interval is determined, and the rotation duration of the current display angle interval is determined according to the uniform rotation speed.

In this embodiment, to determine the to-be-displayed angle interval at the response execution time, the interval entry time of the current display angle interval can be determined through this step. This step can also determine the rotation duration associated with automatic rotation under each display angle interval based on the uniform rotation speed.

The rotation duration can be considered as being associated with the set uniform rotation speed in the automatic view rotation mode, and is used to characterize the duration of switching from the image frame corresponding to one display angle interval to the image corresponding to the next display angle interval on the screen interface.

a12) The time interval from the response execution time to the interval entry time is determined as the rotation interval duration.

a13) If the rotation interval duration is less than the rotation duration, the current display angle interval is kept as the to-be-displayed angle interval.

In this embodiment, when the determined rotation interval duration is less than the rotation duration, it can be considered that the response execution time is still within the current display angle interval. Therefore, the current display angle interval can be kept unchanged and still used as the to-be-displayed angle interval at the response execution time.

a14) If the rotation interval duration reaches the rotation duration, the to-be-displayed angle interval is determined according to the interval angle value of the current display angle interval and the set rotation step.

In this embodiment, when the determined rotation interval duration is less than the set interval threshold, it can be considered that the condition for triggering entry into the next display angle interval is met at the response execution time. Therefore, a new display angle interval is determined as the to-be-displayed angle interval through this step.

It should be noted that when dividing the 360-degree panoramic view into display angle intervals, each display angle interval corresponds to an interval angle value. This step can obtain the interval angle value corresponding to the current display angle interval, and the maximum angle value and the minimum angle value in the interval angle value can be recorded as the interval angle value of the current display angle interval. At the same time, each display angle interval formed by division in this embodiment has the same interval angle value, and the angle amplitude corresponding to the interval angle value can be regarded as the set rotation step of this embodiment.

In this embodiment, after knowing the interval angle value of the current display angle interval, combined with the set rotation step, the maximum angle value and the minimum angle value in the interval angle value can be respectively added to the angle amplitude representing the set rotation step. The interval angle value composed of the newly obtained maximum angle value and minimum angle value represents the newly determined to-be-displayed angle interval.

It should be noted that in this case, it can be considered that the display angle interval of the view rotation of the target vehicle has changed, which is equivalent to re-determining the to-be-displayed angle interval based on the current display angle interval.

The above technical solution of this embodiment provides the specific determination process of the current display angle interval in the automatic view rotation mode. The to-be-displayed angle interval determined in this way better realizes the automatic uniform rotation of the panoramic view of the target vehicle.

On the basis of this first optional embodiment, determining the to-be-displayed angle interval based on the current display angle interval and the rotation phase corresponding to the passive rotation mode can be further specified as the following steps:

b11) The interval angle value of the current display angle interval is determined.

In this embodiment, when dividing the 360-degree panoramic view into a plurality of display angle intervals, each display angle interval corresponds to an interval angle value, which is recorded as the interval angle value of the display angle interval. This embodiment preferably performs uniform division of 360 degrees, so each display angle interval has the same interval angle value. This step can obtain the interval angle value.

b12) When the passive rotation mode corresponds to the third-party sliding control execution phase, the to-be-displayed angle interval is determined according to the interval angle value and the current sliding distance of the sliding trajectory formed by the third-party sliding control.

In this embodiment, when the passive rotation mode corresponds to the third-party sliding control execution phase, in one implementation of determining the to-be-displayed angle interval, the sliding distance of the third-party sliding control can be associated with the rotation angle of the view rotation. The larger the sliding distance within the same time interval, the larger the rotation angle driving the view rotation can be considered. At the same time, each display angle interval also corresponds to an interval angle value. Thus, based on the rotation angle and the interval angle value of the display angle interval, the current display angle interval corresponding to the third-party sliding control at the response execution time can be effectively determined.

Further, determining the to-be-displayed angle interval according to the interval angle value and the current sliding distance of the sliding trajectory formed by the third-party sliding control can be specifically specified as the following steps:

b121) The current sliding distance according to the sliding coordinate points associated with the sliding trajectory formed by the third-party sliding control.

In this embodiment, it can be considered that this step and the following steps are the determination process of the current display angle interval when the passive view rotation mode is in the third-party sliding control execution phase. Specifically, this step can obtain the sliding coordinate points forming the sliding trajectory when the third-party sliding control slides in the screen display area, and the current sliding distance is determined based on the sliding coordinate points.

b122) The sliding rotation angle corresponding to the current sliding distance is determined according to the preset distance-angle mapping information.

In this embodiment, mapping information can be preset for the sliding distance under passive view rotation. The mapping information can be a mapping between the sliding distance and the rotation angle to be rotated, which is recorded as distance-angle mapping information in this embodiment. This step can search the distance-angle mapping information for the rotation angle to be rotated corresponding to the current sliding distance, which is recorded as the sliding rotation angle.

b123) If the sliding rotation angle is less than the set angle threshold, the current display angle interval is kept as the to-be-displayed angle interval.

In this embodiment, to avoid the impact of the operator's accidental touch on the screen interface on the view rotation, a touch response condition is set. This embodiment records the touch response condition as an orientation adjustment condition. For example, the orientation adjustment condition can be determined by a set angle threshold. If the sliding rotation angle is less than the set angle threshold, it is considered that the current situation may be an accidental touch by the operator, or the sliding angle is lower than the interval angle value of the display angle interval. At this time, this step can keep the previously determined current display angle interval unchanged.

In some embodiments, the set angle threshold can be preferably set to the angle amplitude corresponding to the interval angle value of the display angle interval, but the set threshold is not greater than twice the angle amplitude.

b124) If the sliding rotation angle is greater than or equal to the set angle threshold, the to-be-displayed angle interval is determined according to the interval angle value of the current display angle interval and the set rotation step.

In this embodiment, when the sliding rotation angle is greater than or equal to the set angle threshold, it can be considered that the adjustment condition of the display angle interval is met. At this time, the maximum angle value and the minimum angle value in the interval angle value can be respectively added to the angle amplitude as the set rotation step according to the interval angle value of the current display angle interval to obtain a new maximum angle value and a new minimum angle value, so as to form a new interval angle value. The new interval angle value represents the adjusted to-be-displayed angle interval.

b13) When the passive rotation mode corresponds to the buffer rotation phase after the third-party sliding control stops, the to-be-displayed angle interval is determined according to the interval angle value and the sliding speed when the third-party sliding control stops.

In this embodiment, when the passive rotation mode corresponds to the buffer rotation phase after the third-party sliding control stops, in one implementation of determining the to-be-displayed angle interval, the buffer parameter can be first determined through the sliding speed when the third-party sliding control stops, and the acceleration value for deceleration in this buffer phase can be further determined. Finally, the current display angle interval in this buffer phase can be determined according to the acceleration value, the sliding speed, and the time interval from the stop time.

Further, determining the to-be-displayed angle interval according to the interval angle value and the sliding speed when the third-party sliding control stops can be specifically specified as the following steps:

b131) The sliding speed and sliding stop orientation corresponding to the stop time of the third-party sliding control is obtained, and the time interval from the stop time of the third-party sliding control to the response execution time is determined.

In this embodiment, it can be considered that this step and the following steps are the determination process of the current display angle interval when the passive view rotation mode is in the buffer rotation phase. Specifically, the data information required for determining the current display angle interval in this buffer phase, such as the sliding speed and the sliding stop orientation, can be first obtained through this step. The sliding stop orientation can be considered as the display angle interval determined when the third-party sliding control stops, or the display angle interval to which the view is rotated. This step can also obtain the time interval from the stop time of the third-party sliding control to the response execution time.

b132) The buffer acceleration value is determined according to the sliding speed and the pre-given buffer parameter.

In this embodiment, the deceleration buffer parameter may be an empirical value determined in advance through training and testing in different application scenarios during the method design phase. The deceleration buffer parameter may be a power value or a logarithmic value, which is not specifically limited in this embodiment.

In one implementation method, this step can determine the product value obtained by multiplying the sliding speed by the deceleration buffer parameter as the buffer acceleration value. It should be noted that the buffer acceleration value is specifically used to decelerate the sliding speed at the time of stopping to ensure that the view rotation can be stopped after the buffer rotation for a certain period of time.

b133) The buffer rotation angle is determined according to the buffer acceleration value and the time interval.

For example, this step can determine the sliding distance generated from the stop time of the third-party sliding control to the response execution time based on the buffer acceleration value, the sliding speed, and the time interval, and then determine the buffer rotation angle formed by the buffer rotation within this time interval by combining the distance-angle mapping information described in the above embodiment again.

b134) The to-be-displayed angle interval is determined according to the interval angle value and the buffer rotation angle.

In this embodiment, this step can also compare the buffer rotation angle with the angle amplitude described in the above embodiment. If the buffer rotation angle is less than the angle amplitude, it is considered that the to-be-displayed angle interval is still the display angle interval determined at the stop time of the third-party sliding control; if the buffer rotation angle is equal to the angle amplitude, it is considered that the adjustment condition of the to-be-displayed angle interval is met, and the new to-be-displayed angle interval can be determined through the display angle interval determined at the stop time of the third-party sliding control; in addition, if the buffer rotation angle is greater than the angle amplitude, the ratio of the angle amplitude to the buffer rotation angle can be calculated, and the specific value of the ratio rounded can be considered as the number of times the angle amplitude is added on the basis of the display angle interval corresponding to the stop time of the third-party sliding control. The display angle interval corresponding to the finally determined interval angle value can be considered as the to-be-determined to-be-displayed angle interval.

The above technical solution of this embodiment provides the specific determination process of the current display angle interval in the passive view rotation mode. The to-be-displayed angle interval determined in this way better realizes the free-speed rotation of the target vehicle view display following the third-party sliding control and the buffer view rotation after the sliding control stops, enriching the display forms of the panoramic view of the target vehicle.

It should be noted that, unlike the existing method of directly rotating the angle of the three-dimensional model associated with the target vehicle to realize the screen display of the target vehicle from different perspectives, this embodiment can realize the view display of the target vehicle by rendering the to-be-displayed image frame under the to-be-displayed angle interval.

It should be noted that rendering of image frames can be realized through a rendering tool. Generally, the presentation on the screen interface is performed in frames as units. Rendering of image frames by a rendering tool is equivalent to forming rendering frames of image frames; at the same time, considering that the to-be-displayed image frame corresponds to a to-be-displayed angle interval, there is a certain rotation duration when rotating under the to-be-displayed angle interval, that is, it is equivalent that the display of one image frame requires multiple frames of rendering to ensure that the to-be-displayed angle interval is used to present the image content of the to-be-displayed image frame.

This embodiment is equivalent to decomposing the display of the to-be-displayed image frame under the to-be-displayed angle interval into a plurality of to-be-displayed rendering frames, and each to-be-displayed rendering frame needs to be realized by rendering the to-be-displayed image frame through a rendering tool. In the implementation of rendering the to-be-displayed image frame through a rendering tool, to ensure the fluency of the to- be-displayed rendering frame formed by rendering under the view display, it is necessary to ensure that the rendering timing of the rendering is aligned with the frame event execution time of the execution device.

In this embodiment, the execution device can be considered as the execution subject of the method provided in this embodiment, and the frame event of the execution device can be considered as the rendering frame event of the execution device. To realize the alignment between the rendering tool and the frame event execution time of the execution device, this embodiment can monitor the rendering frame event of the execution device through this step to obtain the start execution time of each rendering frame event, so as to meet the rendering of the to-be-displayed image frame at each rendering frame event through the rendering tool at the execution time of the rendering frame event. Finally, the to-be-displayed rendering frame formed by rendering can be displayed on the screen interface as the to-be-displayed image frame.

From the above description, it can be seen that for the display of the to-be-displayed image frame, it is equivalent to requiring multiple frames of rendering of the to-be-displayed image frame. In one implementation method of multiple frames of rendering, after completing the rendering of the involved to-be-displayed rendering frame when the execution condition of the rendering frame event is met, the monitoring of the execution time of the next rendering frame event can be directly performed, so as to use the determined execution time of the next rendering frame event as the execution time of the new to-be-displayed rendering frame. Thus, after reaching the execution time of the new to-be-displayed rendering frame, the determined to-be-displayed image frame is rendered and displayed again.

The display area of the to-be-displayed rendering frame formed by rendering in this step is the screen display area, which can be considered as the display area for the view display of the target vehicle. The display area can be the entire screen interface or a set area on the screen interface.

As a second optional embodiment of this embodiment, on the basis of the above embodiment, continuing the above description, the specific implementation process of displaying the to-be-displayed image frame can be described as:

a2) The event execution time of the rendering event corresponding to the to-be-displayed image frame monitored in advance is obtained.

In this embodiment, the event execution time can be obtained by monitoring the rendering frame event in advance.

b2) After reaching the event execution time, the to-be-displayed image frame is rendered and displayed based on the rendering attribute information of the rendering tool and the image data information of the to-be-displayed image frame.

In this embodiment, when the execution time of the execution logic reaches the event execution time, it is equivalent to realizing the time alignment between the frame event of the execution device and the rendering event. Thus, the rendering of the current image frame can be performed through this step. In some embodiments, the rendering attribute information of the rendering tool may include the width information and height information of the rendering frame to be formed, as well as the device resolution information when the rendering tool is running. The image data information may be the pixel information of the pixel points in the current image frame, such as color value and resolution. This step can use a rendering tool to complete the rendering of the rendering frame event corresponding to the to-be-displayed image frame by combining the obtained information required for rendering, thereby forming the display of the to-be-displayed image frame formed by rendering. The to-be-displayed image frame can be displayed in real-time in the screen display area in the form of a global view display.

It should be noted that the monitoring of the event execution time needs to be performed in advance. This embodiment can directly monitor the event execution time of the next rendering frame event after executing one rendering frame event for the continuous rendering of the to-be-displayed image frame within the corresponding rotation duration.

In this embodiment, the rendering of image frames in the form of rendering frame events runs through the entire view display of the target vehicle. Regardless of the view rotation mode or different view display modes, as long as there is a demand for rendering image frames, the rendering of image frames needs to be realized based on the above steps of this embodiment.

It should be noted that the time interval between two adjacent rendering frame events is not always constant. In the view rotation mode, if the rotation speed of the view rotation is adjusted, that is, the switching speed of the image frames presented in the display angle interval is adjusted, the event execution time of the rendering frame event will also be adjusted accordingly. For example, when the rotation speed generated under the third-party sliding control increases, the time interval between two adjacent rendering frame events is correspondingly shortened; the rotation speed generated in the buffer rotation phase after the third-party sliding control stops gradually decreases, so the time interval between two adjacent rendering frame events is correspondingly lengthened. The specific event execution time of the rendering frame event can be determined in advance through the monitoring step of this embodiment.

The above technical solution of this embodiment adopts the form of rendering image frames by a rendering tool instead of the existing view display realized by rotating the rotation angle of the three-dimensional model of the target vehicle. At the same time, in the rendering of image frames, the monitoring of the rendering frame event is considered to ensure the alignment between the rendering timing and the frame event execution time of the execution device. Through the above technical solution of this embodiment, the performance waste of computing resources is greatly reduced, and the problems of frame freezing and unsmooth view display are effectively solved.

As a third optional embodiment of this embodiment, on the basis of the above embodiment, when the target object is a target vehicle, the method can be further optimized to include the following steps:

a3) In response to a door-open display operation triggered relative to the target vehicle, a door-open view display mode of the target vehicle is entered, and the door-open view display is performed according to a set door-open display strategy.

It should be noted that this third optional embodiment adds the implementation operation of the panoramic view display in other view display modes to the provided method. The other view display modes are preferably a door-open view display mode, which can be entered by triggering a door-open display function item, or by touching or clicking the displayed door in the screen display area with a cursor. This embodiment can analyze from the above trigger that there is currently a demand for door-open display, which is equivalent to requiring a door-open operation.

By entering the door-open view display mode through this step, the door-open view display can be performed according to the door-open display strategy corresponding to this mode. In some embodiments, the door-open display strategy can be used to limit the display execution logic of the door-open view display. One of the display execution logics can be to display the door-open process in a slow-in and slow-out animation form. For example, the door-open display is started at a slow rotation speed, then the display rotation speed is gradually increased, and after rotating to a certain display angle interval, the display rotation speed is started to be reduced and gradually kept the speed at a low value to start uniform rotation, or the rotation speed is directed reduced to 0 and then a uniform rotation starts at a rotation speed.

In the implementation of the slow-in and slow-out animation by the door-open display strategy in this embodiment, the involved rotation speed can be determined through the buffer parameter described above.

b3) After receiving an end trigger for the door-open view display, the target vehicle is controlled to enter the view display in the automatic rotation mode.

In this embodiment, after entering a specific view display mode, it is also possible to exit the corresponding view display mode according to the received corresponding end trigger operation. For example, after entering the door-open view display mode through the above steps, it can be determined whether to exit the door-open view display through this step.

Specifically, the end trigger for the door-open view display can be realized by directly triggering an end control for the door-open view display; or the end trigger can be automatically generated when no other operation instruction is received after a set time length in the door-open view display. Based on the end trigger achieved in the above way, the subsequent steps can directly enter the automatic view rotation mode to continue the object display in this mode. At this time, the object display performed in the automatic view rotation mode can be the automatic view rotation display that continues to maintain the door-open state, or the view rotation display that returns to the default state of the target vehicle (such as the door-closed state).

In addition, if a related rotation operation of the third-party sliding control is detected in the door-open view display mode, the subsequent steps can respond to the trigger of the third-party sliding control to enter the passive view rotation mode and continue the view display of the target vehicle in this mode. Similarly, the object display performed when entering the passive view rotation mode from the door-open view display mode can be the passive view rotation display that continues to maintain the door-open state, or the passive view rotation display that returns to the default state of the target vehicle.

It should be understood that the object display method provided in this embodiment is not limited to the above view display modes mentioned in the embodiment. It can also have displays of other function items. For example, a zoom-in display trigger can be performed on a local image area of the image frame presented in the screen display area, and then a high-definition image of the zoomed-in local image area can be displayed.

The above technical solution of this embodiment provides the characteristic description of other display forms of object display, which better enriches the diversification of function implementation of object display.

Further, as an implementation method of door-open view display, performing door-open view display according to a set door-open display strategy can be specifically specified as:

a31) A plurality of door-open image frames captured when the target vehicle is in a door-open state are obtained, and each door-open image frame corresponds to a different display angle interval.

In this embodiment, during the image capture phase, image capture in more than one shooting state is performed for different display angle intervals. It can perform image capture of the exterior of the entire vehicle, image capture of the interior of the target vehicle, and image capture of the target vehicle in a door-open state. Based on this, the door-open images captured for each different display angle interval in the door-open state can be obtained through this step.

Steps a32) and a33) below of this embodiment provide an implementation method for performing door-open view display according to a set door-open display strategy. In this implementation method, the image frames in the door-open state are required to be rotated in a view in a slow-in and slow-out form. The slow-in and slow-out under view rotation can be realized by providing different view rotation speeds for different display angle intervals. Thus, the view rotation speed corresponding to different display angle intervals can be first determined through the following step a32).

a32) The view rotation speed for rotating to different display angle intervals is determined according to the pre-determined buffer parameter and the average rotation speed.

In this embodiment, for the slow-in and slow-out view display, it can be specifically described as: in the 360-degree view display, 180 degrees can be used as the division threshold for slow-in and slow-out, so that in the view rotation from 0 degrees to 180 degrees, the view rotation speed is gradually accelerated, and the display angle interval corresponding to 180 degrees can be ensured to have a preset relatively high rotation speed, which can be a preset average rotation speed; and in the view rotation from 180 degrees to 360 degrees, the view rotation speed is gradually decelerated, so that the display angle interval corresponding to 360 degrees has a relatively low rotation speed, or the rotation speed is directly reduced to 0.

To achieve the above view rotation effect, this embodiment can determine different buffer parameters for different display angle intervals. For example, this embodiment can set the buffer parameter in the form of a power function, where the exponent can be an empirical value determined through training and testing in different scenarios during the method design phase, and the exponent is set to a constant value; the base can be determined according to the number of display angle intervals divided by 360 degrees. For example, when 360 degrees is divided into 36 display angle intervals, the ratio of 1 to 18 (half of 36) can be used as the growth step of the base. An initial value is determined for the base as the base value of the first display angle interval. Subsequently, for the display angle intervals up to 180 degrees and before, the base is added with the growth step on the basis of the base corresponding to the previous display angle interval; for the display angle intervals after 180 degrees, the base is subtracted by the growth step on the basis of the base corresponding to the previous display angle interval.

Through the above implementation method, a buffer parameter can be determined for each different display angle interval corresponding to 360 degrees. This step can determine the product value of the buffer parameter and the set average rotation speed as the view rotation speed corresponding to the corresponding display angle interval.

Based on the view rotation speed of each display angle interval described above, the interval duration for switching from the door-open image of the display angle interval to the door-open image of the next display angle interval can be determined. It can be found that the faster the view rotation speed, the shorter the interval duration required for switching.

a33) During the rotation according to each of the view rotation speeds, the to-be-displayed door-open image frames corresponding to different display angle intervals are displayed.

In this embodiment, the process of door-open view display is equivalent to the process of view rotation according to the view rotation speed corresponding to each of the above display angle intervals. For each display angle interval, when it is used as the current display angle interval, the corresponding door-open image can be obtained. Thus, this step can also monitor the rendering frame event to render the door-open image corresponding to the current display angle interval. The rendering process is the same as that described in the above embodiment, which will not be repeated here. Finally, the door-open image can be displayed in the screen display area in the form of a door-open state rendering frame.

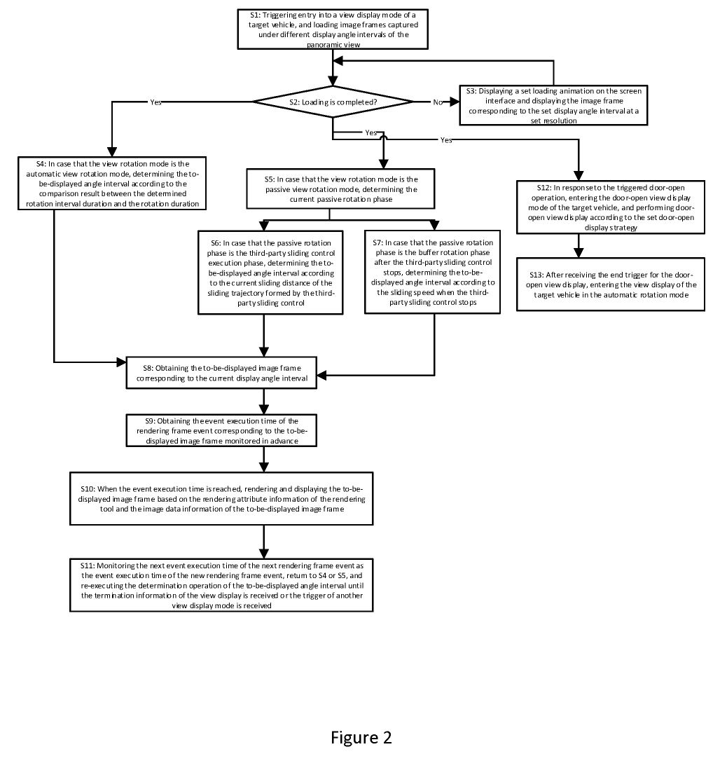

To facilitate a better understanding of the object display method provided in this embodiment, FIG. 2 is an exemplary flowchart of the object display method provided by the embodiment of the present disclosure. As shown in FIG. 2, an exemplary flow is given below to illustrate the execution process of the object display method in practical applications. The target object is described by taking a target vehicle as an example, and specifically may include:

S1: The entry into a view display mode of a target vehicle is triggered, and the image frames captured under different display angle intervals of the panoramic view are loaded.

S2: It is determined whether loading is completed. If not, S3 is executed; if yes, S4, or S5, or S12 is executed.

S3: A set loading animation is displayed on the screen interface and the image frame corresponding to the set display angle interval is displayed at a set resolution, and it returns to continue executing S2.

S4: In case that the view rotation mode is the automatic view rotation mode, the to-be-displayed angle interval is determined according to the comparison result between the determined rotation interval duration and the rotation duration, and S8 is executed.

S5: In case that the view rotation mode is the passive view rotation mode, the current passive rotation phase is determined.

S6: In case that the passive rotation phase is the third-party sliding control execution phase, the to-be-displayed angle interval is determined according to the current sliding distance of the sliding trajectory formed by the third-party sliding control, and S8 is executed.

S7: In case that the passive rotation phase is the buffer rotation phase after the third-party sliding control stops, the to-be-displayed angle interval is determined according to the sliding speed when the third-party sliding control stops, and S8 is executed.

S8: The to-be-displayed image frame corresponding to the current display angle interval is obtained.

S9: The event execution time of the rendering frame event corresponding to the to-be-displayed image frame monitored in advance is obtained.

S10: When the event execution time is reached, the to-be-displayed image frame is rendered and displayed based on the rendering attribute information of the rendering tool and the image data information of the to-be-displayed image frame.

S11: The next event execution time of the next rendering frame event is monitored as the event execution time of the new rendering frame event, return to S4 or S5, and the determination operation of the to-be-displayed angle interval is re-executed until the termination information of the view display is received or the trigger of another view display mode is received.

S12: In response to the triggered door-open operation, the door-open view display mode of the target vehicle is entered, and the door-open view display according to the set door-open display strategy is performed.

S13: After receiving the end trigger for the door-open view display, the view display of the target vehicle in the automatic rotation mode is entered.

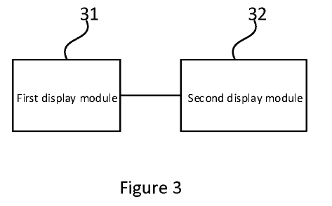

FIG. 3 is a schematic structural diagram of an object display apparatus provided by an embodiment of the present disclosure. This embodiment is applicable to the situation of displaying a 360-degree panoramic view or a partial interval angle view of a target object. The apparatus can be implemented by software and/or hardware and can be configured in a terminal and/or server to implement the object display method in the embodiments of the present disclosure. The apparatus may specifically include: a first display module 31 and a second display module 32.

First display module 31 is configured to trigger entry into a view display mode of a target object, and display one image frame of the target object; the image frame is one image frame in an image set, the image set includes a plurality of image frames corresponding to the target object, and each image frame corresponds to a different display angle interval;

Second display module 32 is configured to respond to a view rotation instruction in a current view rotation mode, determine a to-be-displayed image frame from the image set based on a current display angle interval corresponding to the currently displayed image frame and rotation information in the view rotation mode, and display the to-be-displayed image frame.

The object display apparatus provided in this embodiment pre-shoots image frames of different display angle intervals in a 360-degree all-round manner for each target object to be displayed in a view. Thus, the three-dimensional display effect using the existing three-dimensional model can be visually simulated by displaying image frames under different display angle intervals. The technical solution eliminates the need to construct a three-dimensional model for each object, greatly reducing the view display cost and display difficulty of the object, reducing the performance waste of computing resources, and effectively solving the problems of frame freezing and unsmooth view display. At the same time, in the object display realized by the technical solution provided in this embodiment, the currently required to-be-displayed image frame of the object can be determined according to the different current view rotation modes, that is, the corresponding to-be-displayed image frame varies with the different active view rotation modes, thereby enriching the display forms of object display and reflecting the diversified display of the panoramic view of the object.

Further, the first display module 31 may specifically include:

An automatic display determination unit, which is configured to determine the to-be-displayed angle interval based on the current display angle interval and the uniform rotation speed corresponding to the automatic rotation mode when the view rotation mode is the automatic rotation mode;

A passive display determination unit, which is configured to determine the to-be-displayed angle interval based on the current display angle interval and the rotation phase corresponding to the passive rotation mode when the view rotation mode is the passive rotation mode;

An image display unit, which is configured to determine the image frame corresponding to the to-be-displayed angle interval from the image set as the to-be-displayed image frame.

Further, the automatic display determination unit may be specifically configured to:

Determine the interval entry time of the current display angle interval, and determine the rotation duration of the current display angle interval according to the uniform rotation speed;

Determine the time interval from the response execution time to the interval entry time as the rotation interval duration;

If the rotation interval duration is less than the rotation duration, keep the current display angle interval as the to-be-displayed angle interval;

If the rotation interval duration reaches the rotation duration, determine the to-be-displayed angle interval according to the interval angle value of the current display angle interval and the set rotation step.

Further, the passive display determination unit may specifically include:

An angle determination subunit, which is configured to determine the interval angle value of the current display angle interval;

A first determination subunit, which is configured to determine the to-be-displayed angle interval according to the interval angle value and the current sliding distance of the sliding trajectory formed by the third-party sliding control when the passive rotation mode corresponds to the third-party sliding control execution phase;

A second determination subunit, which is configured to determine the to-be-displayed angle interval according to the interval angle value and the sliding speed when the third-party sliding control stops when the passive rotation mode corresponds to the buffer rotation phase after the third-party sliding control stops.

Further, the first determination subunit may be specifically configured to:

Determine the current sliding distance according to the sliding coordinate points associated with the sliding trajectory formed by the third-party sliding control;

Determine the sliding rotation angle corresponding to the current sliding distance according to the preset distance-angle mapping information;

If the sliding rotation angle is less than the set angle threshold, keep the current display angle interval as the to-be-displayed angle interval;

If the sliding rotation angle is greater than or equal to the set angle threshold, determine the to-be-displayed angle interval according to the interval angle value of the current display angle interval and the set rotation step.

Further, the second determination subunit may be specifically configured to:

Obtain the sliding speed and sliding stop orientation corresponding to the stop time of the third-party sliding control, and determine the time interval from the stop time of the third-party sliding control to the response execution time;

Determine the buffer acceleration value according to the sliding speed and the pre-given buffer parameter;

Determine the buffer rotation angle according to the buffer acceleration value and the time interval;

Determine the to-be-displayed angle interval according to the interval angle value and the buffer rotation angle.

Further, the conditions for the view rotation mode to be the automatic rotation mode include: receiving a trigger operation of a function item for automatic view rotation; or, no other view rotation mode is detected within a set interval duration;

The conditions for the view rotation mode to be the passive rotation mode include: detecting third-party sliding control in the screen display area where image frames are displayed.

Further, the step of the second display module executing the display of the to-be-displayed image frame may include:

Obtain the event execution time of the rendering event corresponding to the to-be-displayed image frame monitored in advance;

After reaching the event execution time, render and display the to-be-displayed image frame based on the rendering attribute information of the rendering tool and the image data information of the to-be-displayed image frame.

Further, the apparatus may further include:

A door-open view module, which is configured to respond to a door-open display operation triggered relative to the target vehicle when the target object is a target vehicle, enter a door-open view display mode of the target vehicle, and perform door-open view display according to a set door-open display strategy;

A view display module, which is configured to control the target vehicle to enter the view display in the automatic rotation mode after receiving an end trigger for the door-open view display.

Further, the door-open view module may be specifically configured to:

Obtain a plurality of door-open image frames captured when the target vehicle is in a door-open state, and each door-open image frame corresponds to a different display angle interval;

Determine the view rotation speed for rotating to different display angle intervals according to the pre-determined buffer parameter and the average rotation speed;

During the rotation according to each of the view rotation speeds, display the to-be-displayed door-open image frames corresponding to different display angle intervals.

The above apparatus can execute the method provided by any embodiment of the present disclosure, and has corresponding functional modules and beneficial effects for executing the method.

It should be noted that each unit and module included in the above apparatus are only divided according to functional logic, but are not limited to the above division, as long as the corresponding functions can be realized; in addition, the specific names of each functional unit are only for the convenience of mutual distinction, and are not used to limit the protection scope of the embodiments of the present disclosure.

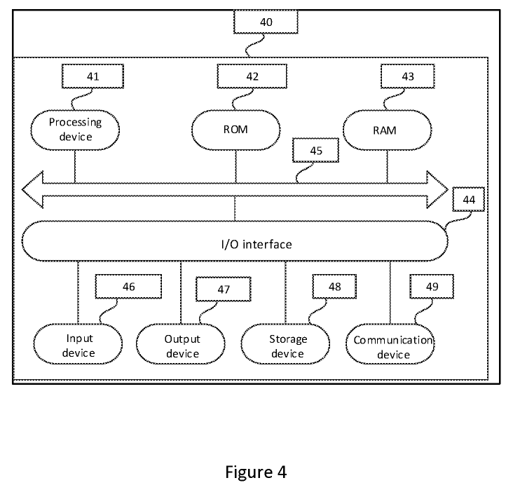

FIG. 4 is a schematic structural diagram of a computer device provided by an embodiment of the present disclosure. Referring to FIG. 4 below, it shows a schematic structural diagram of a computer device (such as a terminal device or a server in FIG. 4) 40 suitable for implementing the embodiments of the present disclosure. The terminal device in the embodiments of the present disclosure may include, but is not limited to, mobile terminals such as mobile phones, notebook computers, digital broadcast receivers, PDAs (Personal Digital Assistants), PADs (Tablet Computers), PMPs (Portable Multimedia Players), vehicle-mounted terminals (such as vehicle-mounted navigation terminals), and fixed terminals such as digital TVs and desktop computers. The computer device shown in FIG. 4 is only an example, and should not impose any limitation on the functions and scope of use of the embodiments of the present disclosure.

As shown in FIG. 4, the computer device 40 may include a processing device (such as a central processing unit, a graphics processing unit, etc.) 41, which may execute various appropriate actions and processes according to a program stored in a read-only memory (ROM) 42 or a program loaded into a random access memory (RAM) 43 from a storage device 48. In the RAM 43, various programs and data required for the operation of the computer device 40 are also stored. The processing device 41, the ROM 42, and the RAM 43 are connected to each other through a bus 45. An input/output (I/O) interface 44 is also connected to the bus 45.

Typically, the following devices may be connected to the I/O interface 44: input devices 46 including, for example, a touch screen, a touch pad, a keyboard, a mouse, a camera, a microphone, an accelerometer, a gyroscope, etc.; output devices 47 including, for example, a liquid crystal display (LCD), a speaker, a vibrator, etc.; storage devices 48 including, for example, a magnetic tape, a hard disk, etc.; and a communication device 49. The communication device 49 may allow the computer device 40 to perform wireless or wired communication with other devices to exchange data. Although FIG. 4 shows a computer device 40 having various devices, it should be understood that it is not required to implement or have all the shown devices. It may alternatively implement or have more or fewer devices.

In particular, according to the embodiments of the present disclosure, the processes described above with reference to the flowcharts may be implemented as computer software programs. For example, the embodiments of the present disclosure include a computer program product including a computer program carried on a non-transitory computer-readable medium, the computer program including program code for executing the methods shown in the flowcharts. In such an embodiment, the computer program may be downloaded and installed from a network through the communication device 49, or installed from the storage device 48, or installed from the ROM 42. When the computer program is executed by the processing device 41, the above-described functions defined in the methods of the embodiments of the present disclosure are executed.

The names of messages or information interacted between multiple devices in the implementations of the present disclosure are only for illustrative purposes and are not intended to limit the scope of these messages or information.

The computer device provided by the embodiment of the present disclosure belongs to the same inventive concept as the object display method provided by the above embodiment. For technical details not described in detail in this embodiment, reference may be made to the above embodiment, and this embodiment has the same beneficial effects as the above embodiment.

An embodiment of the present disclosure provides a computer storage medium on which a computer program is stored, and when the program is executed by a processor, the object display method provided by the above embodiment is implemented.

It should be noted that the computer-readable medium mentioned above in the present disclosure may be a computer-readable signal medium or a computer-readable storage medium, or any combination of the two. A computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In the present disclosure, a computer-readable storage medium may be any tangible medium that contains or stores a program that can be used by or in combination with an instruction execution system, apparatus, or device. In the present disclosure, a computer-readable signal medium may include a data signal propagated in baseband or as part of a carrier wave, in which a computer-readable program code is carried. Such a propagated data signal may take various forms, including but not limited to an electromagnetic signal, an optical signal, or any suitable combination thereof. A computer-readable signal medium may also be any computer-readable medium other than a computer-readable storage medium, and the computer-readable signal medium may send, propagate, or transmit a program for use by or in combination with an instruction execution system, apparatus, or device. The program code contained on the computer-readable medium may be transmitted using any appropriate medium, including but not limited to: an electric wire, an optical cable, radio frequency (RF), etc., or any suitable combination thereof.

In some implementations, a client and a server may communicate using any currently known or future-developed network protocol such as HTTP (HyperText Transfer Protocol), and may be interconnected with any form or medium of digital data communication (e.g., a communication network). Examples of communication networks include a local area network (LAN), a wide area network (WAN), the Internet (e.g., the Internet), and a peer-to-peer network (e.g., an ad hoc peer-to-peer network), as well as any currently known or future-developed network.

The above computer-readable medium may be included in the above computer device; or may exist independently without being incorporated into the computer device.

The above computer-readable medium carries one or more programs, and when the above one or more programs are executed by the computer device, the computer device is caused to:

The computer program code for executing the operations of the present disclosure may be written in one or more programming languages or a combination thereof. The above programming languages include but are not limited to object-oriented programming languages such as Java, Smalltalk, and C++, and also include conventional procedural programming languages such as the "C" language or similar programming languages. The program code may be executed entirely on the user's computer, partially on the user's computer, as an independent software package, partially on the user's computer and partially on a remote computer, or entirely on the remote computer or server. In the case of a remote computer, the remote computer may be connected to the user's computer through any type of network including a local area network (LAN) or a wide area network (WAN), or may be connected to an external computer (e.g., connected through the Internet using an Internet service provider).

The flowcharts and block diagrams in the accompanying drawings illustrate the possible implementation architectures, functions, and operations of the systems, methods, and computer program products according to various embodiments of the present disclosure. In this regard, each block in the flowcharts or block diagrams may represent a module, a program segment, or a part of code, and the module, program segment, or part of code includes one or more executable instructions for implementing the specified logical function. It should also be noted that in some alternative implementations, the functions marked in the blocks may occur in a different order from that marked in the accompanying drawings. For example, two consecutively marked blocks may actually be executed substantially in parallel, or they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs the specified functions or operations, or by a combination of dedicated hardware and computer instructions.

The units involved in the embodiments of the present disclosure may be implemented in software or hardware. In some cases, the name of a unit does not constitute a limitation on the unit itself. For example, the first acquisition unit may also be described as "a unit for acquiring at least two Internet Protocol addresses".

The functions described above in this document may be at least partially executed by one or more hardware logic components. For example, without limitation, exemplary types of hardware logic components that may be used include: Field-Programmable Gate Array (FPGA), Application-Specific Integrated Circuit (ASIC), Application-Specific Standard Product (ASSP), System on Chip (SOC), Complex Programmable Logic Device (CPLD), and the like.

In the context of the present disclosure, a machine-readable medium may be a tangible medium that can contain or store a program for use by or in connection with an instruction execution system, apparatus, or device. A machine-readable medium may be a machine-readable signal medium or a machine-readable storage medium. Machine-readable media may include, but are not limited to, electronic, magnetic, optical, electromagnetic, infrared, or semiconductor systems, apparatuses, or devices, or any suitable combination of the foregoing. More specific examples of machine-readable storage media would include an electrical connection based on one or more wires, a portable computer diskette, a hard disk, a Random Access Memory (RAM), a Read-Only Memory (ROM), an Erasable Programmable Read-Only Memory (EPROM or flash memory), an optical fiber, a portable Compact Disc Read-Only Memory (CD-ROM), an optical storage device, a magnetic storage device, or any suitable combination of the foregoing.

The above description is merely a preferred embodiment of the present disclosure and an explanation of the technical principles applied. It should be understood by those skilled in the art that the scope of disclosure involved in the present disclosure is not limited to the technical solution formed by the specific combination of the above technical features, but also covers other technical solutions formed by any combination of the above technical features or their equivalent features without departing from the above disclosure concept. For example, a technical solution formed by replacing the above features with technical features disclosed in the present disclosure (but not limited to) that have similar functions.

In addition, although the operations are depicted in a specific order, this should not be construed as requiring these operations to be performed in the specific order shown or in sequential order. Under certain circumstances, multitasking and parallel processing may be advantageous. Similarly, although the above discussion includes several specific

implementation details, these should not be construed as limitations on the scope of the present disclosure. Certain features described in the context of separate embodiments may also be implemented in combination in a single embodiment. Conversely, various features described in the context of a single embodiment may also be implemented separately or in any suitable subcombination in multiple embodiments.

Although the subject matter has been described in language specific to structural features and/or methodological logical acts, it should be understood that the subject matter defined in the appended claims is not necessarily limited to the specific features or acts described above. On the contrary, the specific features and acts described above are merely exemplary forms of implementing the claims.

What is claimed is:

1. An object display method, comprising:
triggering entry into a view display mode of a target object, and displaying one image frame of the target object; the image frame is one image frame in an image set, the image set comprises a plurality of image frames corresponding to the target object, and each image frame corresponds to a different display angle interval;
in response to a view rotation instruction in a current view rotation mode, determining a to-be-displayed image frame from the image set based on a current display angle interval corresponding to a currently displayed image frame and rotation information corresponding to the view rotation mode, and displaying the to-be-displayed image frame.

2. The method according to claim 1, wherein the determining the to-be-displayed image frame from the image set based on the current display angle interval corresponding to the currently displayed image frame and the rotation information corresponding to the view rotation mode comprises:
in case that the view rotation mode is an automatic rotation mode, determining a to-be-displayed angle interval based on the current display angle interval and a uniform rotation speed corresponding to the automatic rotation mode;
in case that the view rotation mode is a passive rotation mode, determining the to-be-displayed angle interval based on the current display angle interval and a rotation phase corresponding to the passive rotation mode;
determining the image frame corresponding to the to-be-displayed angle interval from the image set as the to-be-displayed image frame.

3. The method according to claim 2, wherein the determining the to-be-displayed angle interval based on the current display angle interval and the uniform rotation speed corresponding to the automatic rotation mode comprises:
determining an interval entry time of the current display angle interval, and determining a rotation duration of the current display angle interval according to the uniform rotation speed;
determining a time interval from a response execution time to the interval entry time as a rotation interval duration;
in case that the rotation interval duration is less than the rotation duration, keeping the current display angle interval as the to-be-displayed angle interval;
in case that the rotation interval duration reaches the rotation duration, determining the to-be-displayed angle interval according to an interval angle value of the current display angle interval and a set rotation step.

4. The method according to claim 2, wherein the determining the to-be-displayed angle interval based on the current display angle interval and the rotation phase corresponding to the passive rotation mode comprises:
determining an interval angle value of the current display angle interval;
in case that the passive rotation mode corresponds to a third-party sliding control execution phase, determining the to-be-displayed angle interval based on the interval angle value and a current sliding distance of a sliding trajectory formed by the third-party sliding control;
in case that the passive rotation mode corresponds to a buffer rotation phase after the third-party sliding control stops, determining the to-be-displayed angle interval based on the interval angle value and a sliding speed when the third-party sliding control stops.

5. The method according to claim 4, wherein the determining the to-be-displayed angle interval based on the interval angle value and the current sliding distance of the sliding trajectory formed by the third-party sliding control comprises:
determining the current sliding distance according to sliding coordinate points associated with the sliding trajectory formed by the third-party sliding control;
determining a sliding rotation angle corresponding to the current sliding distance according to preset distance-angle mapping information;
in case that the sliding rotation angle is less than a set angle threshold, keeping the current display angle interval as the to-be-displayed angle interval;
in case that the sliding rotation angle is greater than or equal to the set angle threshold, determining the to-be-displayed angle interval according to the interval angle value of the current display angle interval and the set rotation step.

6. The method according to claim 4, wherein the determining the to-be-displayed angle interval based on the interval angle value and the sliding speed when the third-party sliding control stops comprises:
obtaining a sliding speed and a sliding stop orientation corresponding to a stop time of the third-party sliding control, and determining a time interval from the stop time of the third-party sliding control to the response execution time;
determining a buffer acceleration value according to the sliding speed and a pre-given buffer parameter;
determining a buffer rotation angle according to the buffer acceleration value and the time interval;
determining the to-be-displayed angle interval according to the interval angle value and the buffer rotation angle.

7. The method according to claim 1, wherein conditions for the view rotation mode to be an automatic rotation mode comprise: receiving a trigger operation on a view automatic rotation function item; or, no other view rotation mode is detected within a set interval duration;
conditions for the view rotation mode to be a passive rotation mode comprise: detecting a third-party sliding control in a screen display area where image frames are displayed.

8. The method according to claim 1, wherein the displaying the to-be-displayed image frame comprises:
obtaining an event execution time of a rendering event corresponding to the to-be-displayed image frame monitored in advance;
after reaching the event execution time, rendering and displaying the to-be-displayed image frame based on rendering attribute information of a rendering tool and image data information of the to-be-displayed image frame.

9. The method according to claim 1, wherein when the target object is a target vehicle, the method further comprises:
in response to a door-open display operation triggered relative to the target vehicle, entering a door-open view display mode of the target vehicle, and performing a door-open view display according to a set door-open display strategy;
after receiving an end trigger for the door-open view display, controlling the target vehicle to enter a view display in an automatic rotation mode.

10. The method according to claim 9, wherein the performing the door-open view display according to the set door-open display strategy comprises:
obtaining a plurality of door-open image frames captured when the target vehicle is in a door-open state, each door-open image frame corresponding to a different display angle interval;
determining a view rotation speed for rotating to different display angle intervals according to a pre-determined buffer parameter and an average rotation speed;
during rotation according to each of the view rotation speeds, displaying the to-be-displayed door-open image frames corresponding to the different display angle intervals.

11. An object display apparatus, comprising:
a first display module, configured to trigger entry into a view display mode of a target object, and display one image frame of the target object; the image frame is one image frame in an image set, the image set comprises a plurality of image frames corresponding to the target object, and each image frame corresponds to a different display angle interval;
a second display module, configured to respond to a view rotation instruction in a current view rotation mode, determine a to-be-displayed image frame from the image set based on a current display angle interval corresponding to the currently displayed image frame and rotation information in the view rotation mode, and display the to-be-displayed image frame.

12. The object display apparatus according to claim 11, wherein the first display module comprises:
an automatic display determination unit, configured to determine a to-be-displayed angle interval based on the current display angle interval and a uniform rotation speed corresponding to the automatic rotation mode when the view rotation mode is an automatic rotation mode;
a passive display determination unit, configured to determine the to-be-displayed angle interval based on the current display angle interval and a rotation phase corresponding to the passive rotation mode when the view rotation mode is a passive rotation mode;
an image display unit, configured to determine the image frame corresponding to the to-be-displayed angle interval from the image set as the to-be-displayed image frame.

13. The object display apparatus according to claim 12, wherein the automatic display determination unit is configured to:
determine an interval entry time of the current display angle interval, and determine a rotation duration of the current display angle interval according to the uniform rotation speed;
determine a time interval from a response execution time to the interval entry time as a rotation interval duration;
in case that the rotation interval duration is less than the rotation duration, keep the current display angle interval as the to-be-displayed angle interval;
in case that the rotation interval duration reaches the rotation duration, determine the to-be-displayed angle interval according to an interval angle value of the current display angle interval and a set rotation step.

14. The object display apparatus according to claim 12, wherein the passive display determination unit comprises:
an angle determination subunit, configured to determine an interval angle value of the current display angle interval;
a first determination subunit, configured to determine the to-be-displayed angle interval based on the interval angle value and a current sliding distance of a sliding trajectory formed by the third-party sliding control when the passive rotation mode corresponds to a third-party sliding control execution phase;
a second determination subunit, configured to determine the to-be-displayed angle interval based on the interval angle value and a sliding speed when the third-party sliding control stops when the passive rotation mode corresponds to a buffer rotation phase after the third-party sliding control stops.

15. The object display apparatus according to claim 14, wherein the first determination subunit is configured to:
determine the current sliding distance according to sliding coordinate points associated with the sliding trajectory formed by the third-party sliding control;
determine a sliding rotation angle corresponding to the current sliding distance according to preset distance-angle mapping information;
in case that the sliding rotation angle is less than a set angle threshold, keep the current display angle interval as the to-be-displayed angle interval;
in case that the sliding rotation angle is greater than or equal to the set angle threshold, determine the to-be-displayed angle interval according to the interval angle value of the current display angle interval and the set rotation step.

16. The object display apparatus according to claim 14, wherein the second determination subunit is configured to:
obtain a sliding speed and a sliding stop orientation corresponding to a stop time of the third-party sliding control, and determine a time interval from the stop time of the third-party sliding control to the response execution time;
determine a buffer acceleration value according to the sliding speed and a pre-given buffer parameter;
determine a buffer rotation angle according to the buffer acceleration value and the time interval;
determine the to-be-displayed angle interval according to the interval angle value and the buffer rotation angle.

17. The object display apparatus according to claim 11, wherein conditions for the view rotation mode to be an automatic rotation mode comprise: receiving a trigger operation on a view automatic rotation function item; or, no other view rotation mode is detected within a set interval duration;
conditions for the view rotation mode to be a passive rotation mode comprise: detecting a third-party sliding control in a screen display area where image frames are displayed.

18. The object display apparatus according to claim 11, wherein the step of the second display module executing the display of the to-be-displayed image frame comprises:
obtaining an event execution time of a rendering event corresponding to the to-be-displayed image frame monitored in advance;
after reaching the event execution time, rendering and displaying the to-be-displayed image frame based on rendering attribute information of a rendering tool and image data information of the to-be-displayed image frame.

19. A computer device, comprising:
one or more processors;
a storage device, configured to store one or more programs,
when the one or more programs are executed by the one or more processors, the one or more processors implement the object display method according to claim 1.

20. A computer-readable storage medium, on which a computer program is stored, and when the computer program is executed by a processor, the object display method according to claim 1 is implemented.
